(19) United States
(12) Patent Application Publication
(10) Pub. No.: US 2020/0210422 A1
(43) Pub. Date: Jul. 2, 2020

(54) INFORMATION PROCESSING APPARATUS, COMPONENT SELECTION METHOD, AND RECORDING MEDIUM

(71) Applicant: FUJITSU LIMITED, Kawasaki-shi (JP)

(72) Inventor: Tatsuya YAMAMOTO, Kawasaki (JP)

(73) Assignee: FUJITSU LIMITED, Kawasaki-shi (JP)

(21) Appl. No.: 16/700,275

(22) Filed: Dec. 2, 2019

(30) Foreign Application Priority Data
Dec. 26, 2018 (JP) 2018-243479

(51) Int. Cl. G06F 16/2458; G06F 30/39; G06Q 10/06; G06Q 30/02

(52) U.S. Cl. CPC G06F 16/2468; G06F 30/39; G06F 2119/18; G06Q 30/0283; G06Q 10/06315

(57) ABSTRACT

An information processing apparatus includes a memory and a processor coupled to the memory, and is configured to perform generating, on a basis of a first component selection criteria for a first component search performed by a first operator, alternative proposal information by referring to log information about a second component search performed by a second operator with a second component selection criteria which is the same as the first component selection criteria.

### CROSS-REFERENCE TO RELATED APPLICATIONS

The present application is based upon and claims the benefit of priority from the prior Japanese Patent Application No. 2018-243479 filed on Dec. 26, 2018, with the Japanese Patent Office, the entire contents of which are incorporated herein by reference.

### FIELD

The disclosures herein relate to an information processing apparatus, a component selection method, and a recording medium.

### BACKGROUND

In recent years, there is a technique of component search for searching a product requested by a client. In this technique, an alternative component that can be substituted for a component designated by the client is extracted from among registered common components, and this alternative component is used upon approval by the client, so that the requested product can be provided at a low cost with a short delivery time.

In electronic circuit design, to select a component of a product, various sites selling components and the like on the Internet are used to search desired components. The purpose of searching components is different depending on the form of estimates submitted to clients to suggest the product.

In the above-mentioned technique and the like, a technique of component search that assumes any given form of a estimate is disclosed, but in a case where component searches are performed with various forms of estimates, it is impossible to identify which form of estimate the component search assumes. More specifically, in a case where component searches are performed for various purposes, selection criteria according to which the operator selects components are not determined, and therefore, the operator may not be able to obtain component information suitable for the purpose of the component search.

### RELATED-ART DOCUMENTS

### Patent Document

[Patent Document 1] Japanese Laid-Open Patent Publication No. 2006-163843

[Patent Document 2] Japanese Laid-Open Patent Publication No. 2013-175050

[Patent Document 3] Japanese Laid-Open Patent Publication No. 2017-073114

### SUMMARY

According to an aspect of the embodiment, an information processing apparatus includes a memory and a processor coupled to the memory, and is configured to perform generating, on a basis of a first component selection criteria for a first component search performed by a first operator, alternative proposal information by referring to log information about a second component search performed by a second operator with a second component selection criteria which is the same as the first component selection criteria.

The object and advantages of the embodiment will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram for explaining characteristic differences in log information among purposes of component searches;

FIG. 2 is a drawing for explaining an example of component search using collaborative filtering;

FIG. 3 is a drawing illustrating an example of an attribute determination method of an operator;

FIG. 4 is a drawing for explaining a determination example of a proposal type EMS approximate estimate;

FIG. 5 is a drawing for explaining a determination example of a proposal type EMS detailed estimate;

FIG. 6 is a drawing for explaining a determination example of an ODM detailed estimate;

FIG. 7 is a drawing for explaining component selection criteria in a case where an attribute is the proposal type EMS approximate estimate;

FIG. 8 is a drawing for explaining component selection criteria in a case where an attribute is the proposal type EMS detailed estimate;

FIG. 9 is a drawing for explaining component selection criteria in a case where an attribute is an ODM detailed estimate;

FIG. 10 is a drawing illustrating a system configuration example;

FIG. 11 is a drawing illustrating a functional configuration example of a server apparatus;

FIG. 12 is a drawing illustrating a detailed example of a functional configuration of the server apparatus;

FIG. 13 is a flowchart for explaining an outline of similarity determination processing;

FIG. 14 is a flowchart for explaining purpose determination processing;

FIG. 15 is a flowchart for explaining estimate type determination processing performed in step S204-6 of FIG. 14;

FIGS. 16A and 16B are drawings for explaining sessions according to the present embodiment;

FIG. 17 is a drawing illustrating a data example of an attribute recording table in an example of FIGS. 16A and 16B;

FIG. 18 is a drawing for explaining generation processing of a tendency table in step S205 of FIG. 13 and FIG. 14;

FIG. 19 is a figure illustrating a data example of a tendency table;

FIG. 20 is a flowchart for explaining first determination processing in step S231 of FIG. 15;

FIG. 21 is a flowchart for explaining second determination processing in step S233 of FIG. 15;

FIG. 22 is a flowchart for explaining third determination processing in step S235 of FIG. 15; and

FIG. 23 is a flowchart for explaining match determination processing of individual specifications in step S3505 of FIG. 22.

### DESCRIPTION OF EMBODIMENTS

Hereinafter, embodiments of the present invention will be described with reference to the drawings. First, an example of provision of component information performed by collaborative filtering in general will be described. In this example, the purpose of component search in electronic circuit design and the characteristics of each purpose will be explained.

The purposes of component search in electronic circuit design include proposal type EMS approximate estimate, proposal type EMS detailed estimate, and ODM detailed estimate.

In the above, EMS (Electronics Manufacture

Service) is a business that manufactures products based on a client component table. Basically, based on the client's component table, components are selected and the order of manufacture is placed.

Proposal type EMS is a business that receives orders of manufacture by proposing component substitution to the client and providing estimation with components which are beneficial for the client in terms of the cost (advantage in the cost). The proposal type EMS also includes a proposal for replacing a component with another component having an added value, e.g., a higher manufacturing quality, when it is difficult to adjust the cost.

In the proposal type EMS, the design responsibility lies with the client, and the approval of the client is required to adopt the component. The estimate for a proposal type EMS is intended to show the cost potential of the company. As mentioned above, in the proposal type EMS, two stages of estimations including an approximate estimate and a detailed estimate are made.

In the proposal type EMS approximate estimate, a person in a sales department tends to perform component search with an emphasis placed on the ease of procurement.

As a feature of the proposal type EMS approximate estimate, there is a tendency to select products from the same manufacturer rather than sticking to the same specifications. This is based on the procurement viewpoint, and if the seller has already been decided, components can be purchased with partial small-scale changes (minor changes) in the purchase specification, and therefore, the cost for procurement and adjustment can be suppressed. The cost for procurement and adjustment includes personal expenses such as making of contracts.

In other words, since the cost as a whole is desired to be reduced, it may be possible to suggest, in units of components, a component more expensive than the original component. The prices of alternative components may be higher or lower than the prices of the original components when the unit prices of the alternative components and the original components are compared in units of components. Also, in a case of a component that has already been purchased, the shipping cost may be reduced by receiving the component and other components in a single shipment.

In the proposal type EMS detailed estimate, a person in a purchasing department tends to perform component search with an emphasis placed on the performance of a product.

In order to estimate the actual cost, a matching of the component specifications is regarded as most important. An operator in a purchasing department and the like examines the cost of each component in detail, and select a less expensive component. Therefore, when the prices before and after the detailed estimation are compared for each component, the prices of the alternative components do not vary as compared with the prices of the original components, and most of the substitutions are replacements with less expensive components.

Next, ODM (Original Design Manufacturing) is a form of business in which a manufacturer receives an order for design and manufacture based on design specifications given by a client. The component table to be used can be changed freely without requiring any permission from the client. Therefore, the design responsibility lies with the manufacturer.

The ODM detailed estimate is performed by a person in a design department, and there is a tendency to perform component search with an emphasis placed on the performance and the cost. In the component search, only the components advantageous in the cost are searched from the same series, rather than finding components having the same specifications.

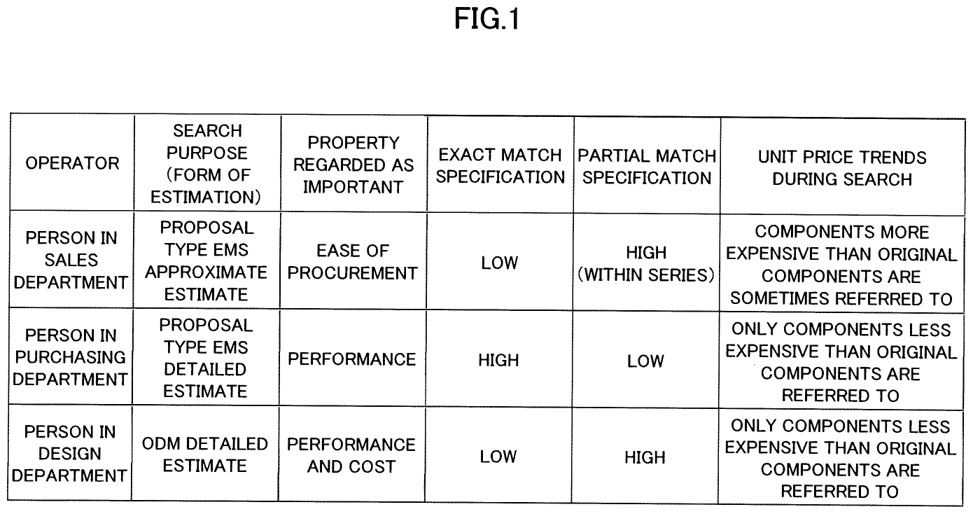

Therefore, the inventor and the like of the present application considered that characteristic differences appear in log information due to the purposes of component searches, and in particular, the form of the estimation which is the purpose of the search is related to a department to which an operator belongs, and the inventor and the like have made a classification as illustrated in FIG. 1.

FIG. 1 is a diagram for explaining characteristic differences in log information among purposes of component searches. In the table illustrated in FIG. 1, items such as a “search purpose”, a “property regarded as important”, “exact match specification”, “partial match specification”, and “unit price trends during the search” are associated with each department to which the operator belongs.

The item “operator” indicates the department to which the operator belongs, and is any one of a sales department, a purchasing department, and a design department. The search purpose indicates a form of an estimate, and is any one of “proposal type EMS approximate estimate”, “proposal type EMS detailed estimate”, and “ODM detailed estimate”. The item “property regarded as important” indicates a property regarded as important when an estimate is generated, and is any one of: the ease of procurement; performance; and performance and cost.

The item “exact match specification” indicates how much an exact match of a specification is desired, and is any one of “high” and “low”. For example, a value “high” indicates that a person who performs a search is more likely to desire an alternative component having a specification that exactly matches that of the original component. A value “low” indicates that a person who performs a search is less likely to desire an alternative component having a specification that exactly matches that of the original component.

The item “partial match specification” indicates how much a partial match of a specification is desired, and is any one of “high” and “low”. For example, a value “high” indicates that a person who performs a search is more likely to desire an alternative component having a specification that partially matches that of the original component. A value “low” indicates that a person who performs a search is less likely to desire an alternative component having a specification that partially matches that of the original component.

However, in a case where the “search purpose” is a proposal type EMS detailed estimate, a search is performed with partial match of specifications within any given series.

The item “unit price trends during the search” indicates whether a person who performs a search tends to refer to a more expensive component or tends to refer to a less expensive component in comparison with the price of the original component prior to the search.

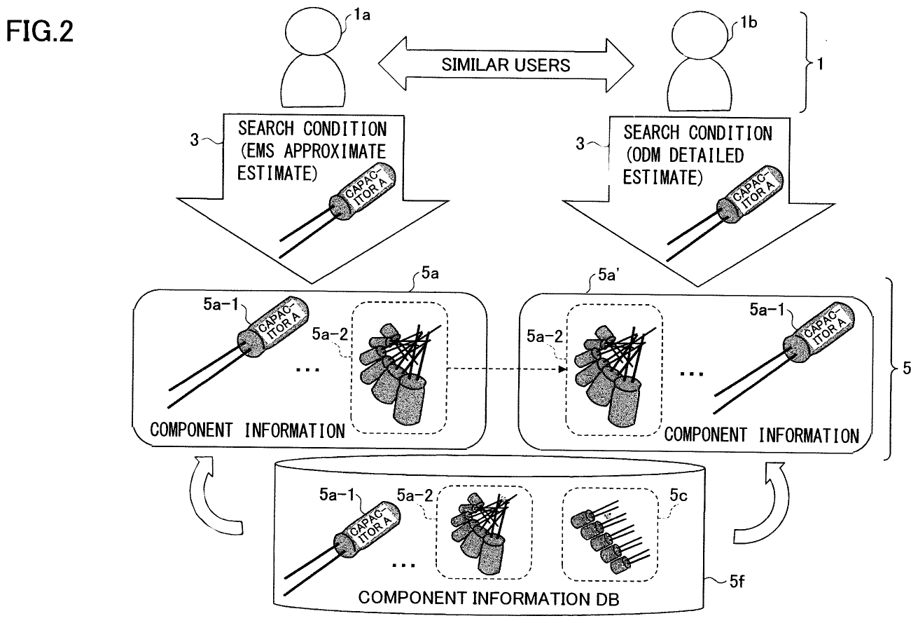

Next, a case where a component search is performed with collaborative filtering will be explained. FIG. 2 is a drawing for explaining an example of component search using collaborative filtering. In FIG. 2, an operator 1a searches a capacitor A with a search condition 3 by using a terminal operated by the operator 1a for the purpose of EMS approximate estimate. The search condition 3 includes information such as a “capacitor A” as a component, a series name, and specifications required for the product.

In the collaborative filtering, on the basis of the search condition 3, in addition to information about the capacitor A from a component information DB (database) 5f, component information 5a including not only the information about the capacitor A but also information about various capacitors similar to the capacitor A is presented to the terminal of the operator 1a.

Normally, the operator 1a accesses component information 5a-1 about the capacitor A to check the price, specifications, and the like. For reference, the operator 1a may check component information about capacitors having specifications similar to that of the capacitor A. However, since the operator 1a has a purpose of EMS approximate estimate, the operator 1a tends to preferentially check component information suitable for the purpose, and does not refer to component information not suitable for the purpose. That is, the operator 1a accesses the component information 5a-1 suitable for the purpose from the component information 5a with emphasis placed on the ease of procurement. In this example, component information 5a-2 extracted from the component information DB 5f by collaborative filtering corresponds to information that is not referred to by the operator 1a.

After the search performed by the operator 1a, the operator 1b performs a search under the search condition 3 specifying the capacitor A just like the operator 1a. However, although the search condition 3 of the operator 1b is the same as that of the operator 1a, it is assumed that, in this case, the search is focused on the performance and the cost for the purpose of the ODM detailed estimate. Hereinafter, the operator 1a, the operator 1b, and other operators may be collectively referred to as operators 1.

In the collaborative filtering, according to the search performed by the operator 1b, the search information of the operator 1a who accessed the information about the same component in the past may be extracted from the log information, and information about components that the operator 1a who has searched in the past has not yet accessed may be suggested.

When the capacitor A is designated by the operator 1a with the same search condition 3 in the past is designated, the component information 5a′ is displayed on the terminal operated by the operator 1b based on the log information. The component information 5a′ includes not only the component information 5a-1 about the capacitor A but also the component information 5a-2 that has not been accessed by the operator 1a who has searched the capacitor A in the past and information about components whose specifications are similar to that of the capacitor A.

However, the component information 5a′ includes considerable amount of component information that does not conform to the ODM detailed estimate which is the purpose of the search performed by the operator 1b, and the component information desired by the operator 1b may not be provided with high accuracy. In such a case, the operator 1b performs a search through trial and error, such as setting additional information in the search condition 3. Hereinafter, the component information 5a, the component information 5a′, and the like are collectively referred to as component information 5.

Even if component information 5c suitable for the ODM detailed estimate which is the purpose of the search performed by the operator 1b is stored in the component information DB 5f, the component information 5c cannot be presented to the operator 1b with high accuracy. This is considered to be due to the fact that collaborative filtering selects the component information to be presented based on the correspondence between the operator, the component of which the information the operator has checked, and the purchased component.

As described above, also, the inventor and the like have found, from a viewpoint different from those in the past, a method for determining the similarity of the operators 1a, 1b, and the like (hereinafter collectively referred to as the operators 1) based on the characteristics of the purposes of the component searches described in FIG. 1. More specifically, in the present embodiment, an estimate type which is a purpose of component search is determined and adopted as an attribute of the operator, so that the similarity of the operator is determined according to the estimate type. Examples of determination criteria will be explained. “Proposal type EMS approximate estimate”, “proposal type EMS detailed estimate”, and “ODM detailed estimate” correspond to estimate types.

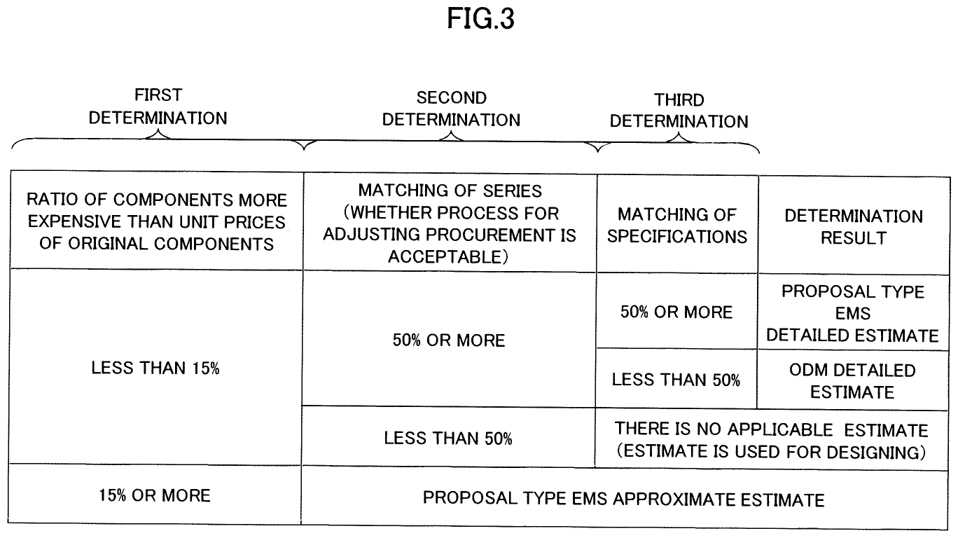

FIG. 3 is a drawing illustrating an example of an attribute determination method of an operator. In FIG. 3, a method in which the operator 1 determines an estimate type on the basis of information about a component designated by the search condition 3 and information about a component accessed by the operator 1 will be explained. A term “access” includes operations such as referring to information about a component and purchasing the component. The component designated in the search condition 3 is a component or a related component indicated by a component table created by a client or a design department, and corresponds to the original component.

In an attribute determination of the operator 1 according to the present embodiment, with respect to log information of the operator 1 in a predetermined period in the past, the following determinations are made:

first determination: a possibility that the search purpose is a proposal type EMS approximate estimate is determined;

second determination: in a case where the search purpose is not the proposal type EMS approximate estimate, a possibility that the search purpose is a proposal type EMS detailed estimate or an ODM detailed estimate is determined; and

third determination: a determination is made as to which of the proposal type EMS detailed estimate or the ODM detailed estimate the search purpose is.

A first determination threshold value, a second determination threshold value, and a third determination threshold value are set for the first determination, the second determination, and the third determination, respectively. In this example, “15%” is set as the first determination threshold value, “50%” is set as the second determination threshold value, and “50%” is set as the third determination threshold value, but these determination threshold values are not limited thereto. As necessary, each of the determination threshold values may be changed.

First, the first determination is performed. In the first determination, in a case where a ratio of a number of accessed records of information about components more expensive than the unit prices of the components designated in the search condition 3 with respect to a number of records of information referred to by the operator 1 from the component information 5 presented in response to the search condition 3 is 15% or more, the purpose of the search is determined to be the proposal type EMS approximate estimate.

In a case where the purpose of the search is determined not to be the proposal type EMS approximate estimate in the first determination, the second determination is performed. In the second determination, a determination is made as to whether a ratio of a number of accessed records of information of which the series match the series of the components designated in the search condition 3 is 50% or more. In a case where the ratio is 50% or more, the third determination is further performed. In a case where the ratio is less than 50%, the purpose of the search is determined to correspond to none of the above estimate types. In this case, it is determined that a search is performed for the purpose of reviewing components to be employed when a product is designed.

In the third determination, a determination is made as to whether a ratio of a number of records of accessed information of which the specification match the specifications of the components designated in the search condition 3 is 50% or more. In a case where the ratio is 50% or more, the purpose of the search is the proposal type EMS detailed estimate. In a case where the ratio is less than 50%, the purpose of the search is the ODM detailed estimate.

The search purpose obtained from the first determination, the second determination, and the third determination is recorded as the attribute of the operator 1. An example of determining the attribute of the operator 1 on the basis of the first to third determination threshold values in the attribute determination method of FIG. 3 will be hereinafter explained.

In the present embodiment, any given period of time is defined as a single session, and the attribute of the operator 1 is determined from the log information in the defined single session. A method for setting the session will be explained later. For each session, initial log information is adopted as criteria information 9. The initial log information may be the log of the component information referred to by the operator 1, but here the initial log information is considered to correspond to the search condition 3.

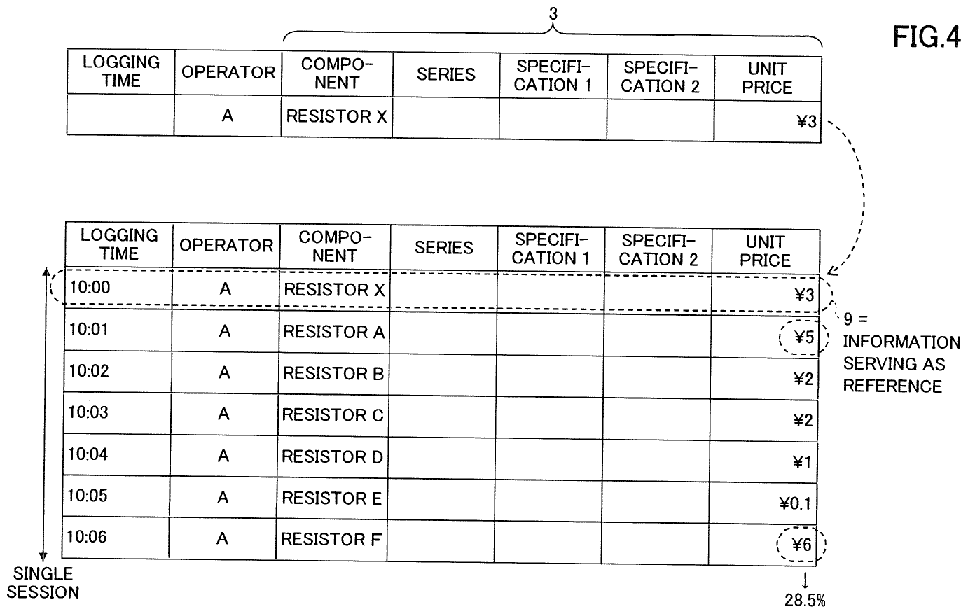

FIG. 4 is a drawing for explaining a determination example of a proposal type EMS approximate estimate. In FIG. 4, for example, it is assumed that the initial log information about an operator A indicates that, in the defined single session, the search condition 3 is a component “resistor X” at a unit price of “3 Yen”. The operator A is an example of one of the operators 1.

In the example of FIG. 4, there are 7 records in the single session. The criteria information 9 is compared with the log information of each of the 6 records recorded after the criteria information 9 to determine the attribute of an operator A.

In the first determination, the prices are compared between the criteria information 9 and the log information. The number of records indicating unit prices higher than the unit price “3 yen” of the criteria information 9 is two records, i.e., “5 Yen” of a component “resistor A” and “6 Yen” of a component “resistor F”. Therefore, in the single session, a ratio of the number of records “2” indicating the higher unit prices with respect to the total number of records “7” is 28.5% (=2/7).

Since the first determination threshold value of the first determination is 15% or more as illustrated in FIG. 3, the purpose of the search by the operator A can be determined to be the proposal type EMS approximate estimate.

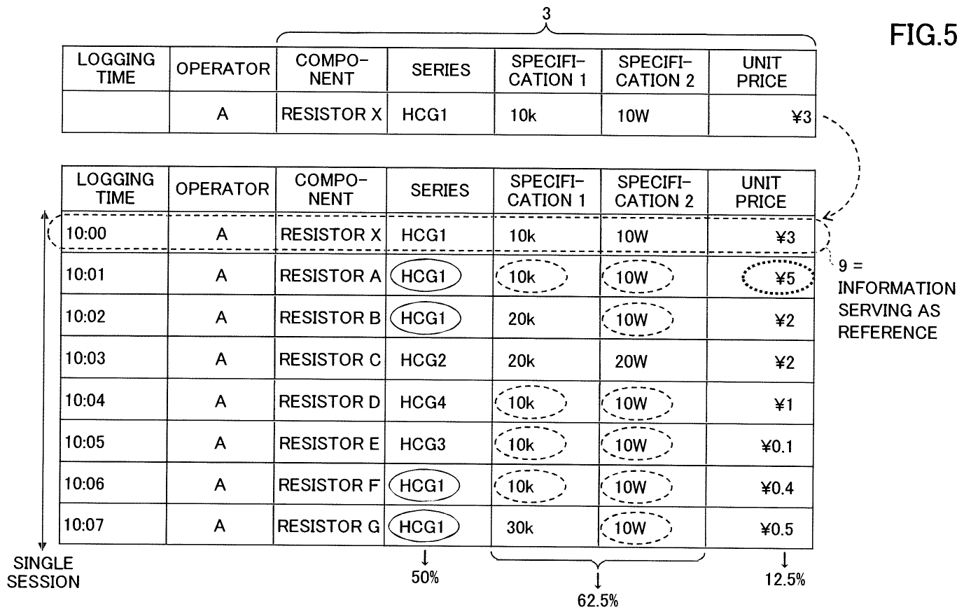

FIG. 5 is a drawing for explaining a determination example of the proposal type EMS detailed estimate. In FIG. 5, for example, it is assumed that the initial log information about the operator 1 indicates that, in the defined single session, the search condition 3 includes a component “resistor X”, a series “HCG1”, a specification 1 “10k”, a specification 2 “10W”, and a unit price “3 Yen”.

In the example of FIG. 5, there are 8 records in the single session. The criteria information 9 is compared with the log information of each of the 7 records recorded subsequent to the criteria information 9 to determine the attribute of the operator A.

In the first determination, the prices are compared between the criteria information 9 and the log information. The number of records indicating unit prices higher than the unit price “3 yen” of the criteria information 9 is one record, i.e., “5 Yen”. Therefore, in the single session, a ratio of the number of records “1” indicating the higher unit prices with respect to the total number of records “8” is 12.5% (=1/8).

Since the first determination threshold value of the first determination is less than 15% as illustrated in FIG. 3, the purpose of the search by the operator A is determined not to be the proposal type EMS approximate estimate, and the second determination is performed.

In the second determination, a determination is made as to whether the series matches or not between the criteria information 9 and the log information. The number of records of which the series match the series “HCG1” of the criteria information 9 is four records, i.e., components “resistor A”, a “resistor B”, a “resistor F”, and a “resistor G”. Therefore, in the single session, a ratio of the number of records “4” having matched series with respect to the total number of records “8” is 50% (=4/8).

Since the second determination threshold value of the second determination is 50% or more as illustrated in FIG. 3, the third determination is further performed to determine the purpose of the search by the operator A.

In the third determination, a determination is made as to whether the specifications match. The record of the criteria information 9 includes the specification 1 “10k” and the specification 2 “10W”. Records that match any one of these specifications 1 and 2 are records of components “resistor A”, “resistor B”, “resistor D”, “resistor E”, “resistor F”, and “resistor G”, and there are 10 matching items in total. Therefore, in the single session, a ratio of 10 matching items where the specification values match with respect to the number of items “16” where the specification values are set in 8 records is 62.5% (=10/16).

Since the third determination threshold value of the third determination is 50% or more as illustrated in FIG. 3, the purpose of the search by the operator A can be determined to be the proposal type EMS detailed estimate.

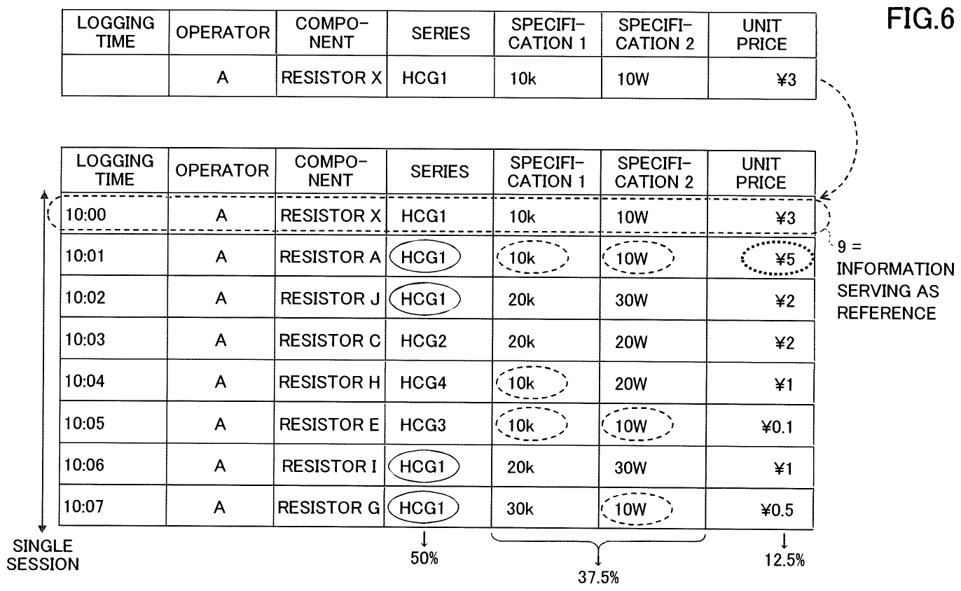

FIG. 6 is a drawing for explaining a determination example of an ODM detailed estimate. In FIG. 6, for example, it is assumed that the initial log information about the operator 1 indicates that, in the defined single session, the search condition 3 includes a component “resistor X”, a series “HCG1”, a specification 1 “10k”, a specification 2 “10W”, and a unit price “3 Yen”.

In the example of FIG. 6, there are 8 records in the single session. The criteria information 9 is compared with the log information of each of the 7 records recorded subsequent to the criteria information 9 to determine the attribute of the operator A.

In the first determination, the prices are compared between the criteria information 9 and the log information. The number of records indicating unit prices higher than the unit price “3 yen” of the criteria information 9 is one record, i.e., “5 Yen”. Therefore, in the single session, a ratio of the number of records “1” indicating the higher unit prices with respect to the total number of records “8” is 12.5% (=1/8).

Since the first determination threshold value of the first determination is less than 15% as illustrated in FIG. 3, the purpose of the search by the operator A is determined not to be the proposal type EMS approximate estimate, and the second determination is performed.

In the second determination, a determination is made as to whether the series matches or not between the criteria information 9 and the log information. The number of records of which the series match the series “HCG1” of the criteria information 9 is four records, i.e., components “resistor A”, “resistor J”, “resistor I”, and “resistor G”. Therefore, in the single session, a ratio of the number of records “4” having matched series with respect to the total number of records “8” is 50% (=4/8).

Since the second determination threshold value of the second determination is 50% or more as illustrated in FIG. 3, the third determination is further performed to determine the purpose of the search by the operator A.

In the third determination, a determination is made as to whether the specifications match. The record of the criteria information 9 includes the specification 1 “10k” and the specification 2 “10W”. Records that match any one of these specifications 1 and 2 are records of components “resistor A”, “resistor H”, “resistor E”, and “resistor G”, and there are 6 matching items in total. Therefore, in the single session, a ratio of 6 matching items where the specification values match with respect to the number of items “16” where the specification values are set in 8 records is 37.5% (=6/16).

Since the third determination threshold value of the third determination is less than 50% as illustrated in FIG. 3, the purpose of the search by the operator A can be determined to be the ODM detailed estimate.

According to FIG. 4 to FIG. 6, the operator A can determine which of the proposal type EMS approximate estimate, the proposal type EMS detailed estimate, and the ODM detailed estimate the purpose of the search is. Even if the first determination yields a positive result, when the result of the second determination is negative, it is determined that there is no applicable estimate.

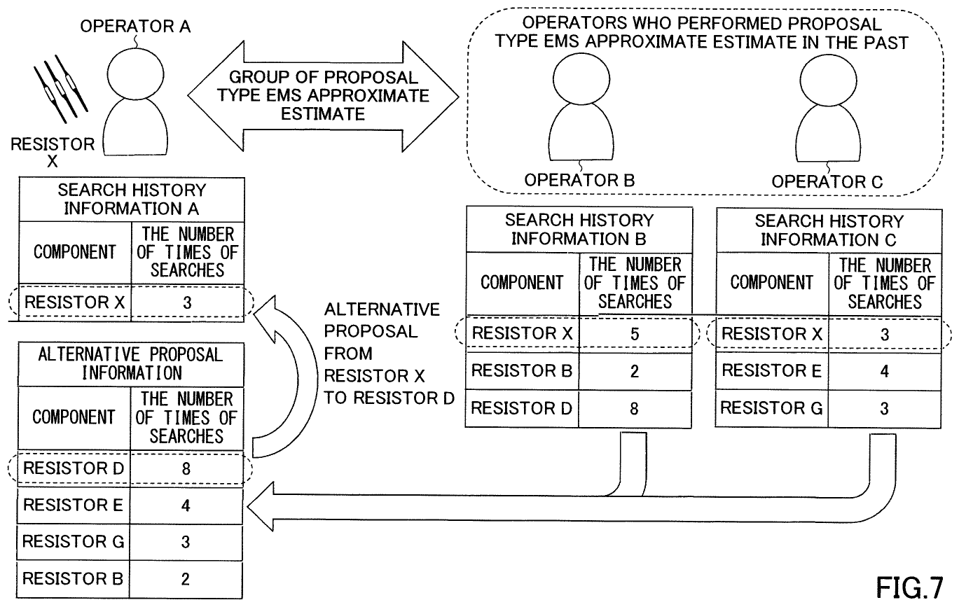

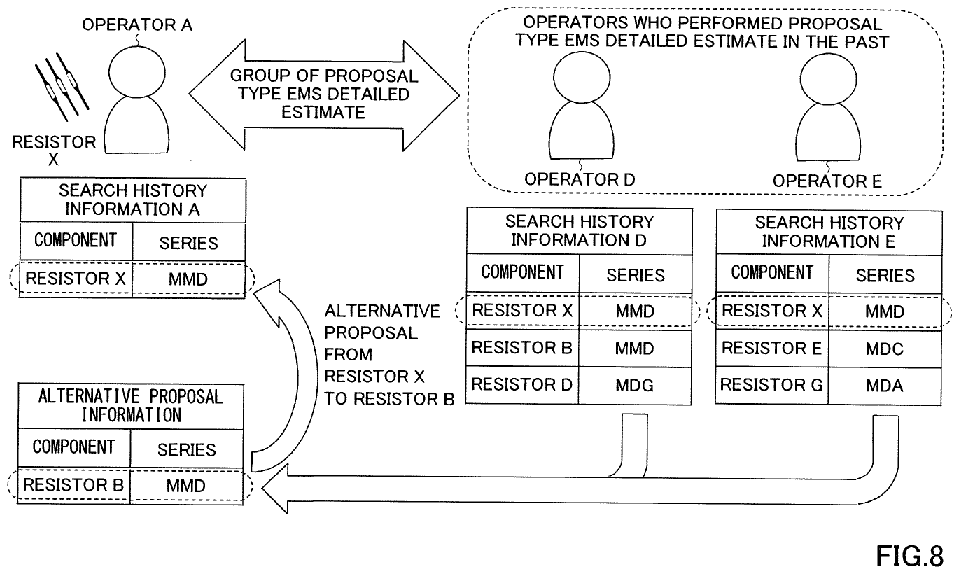

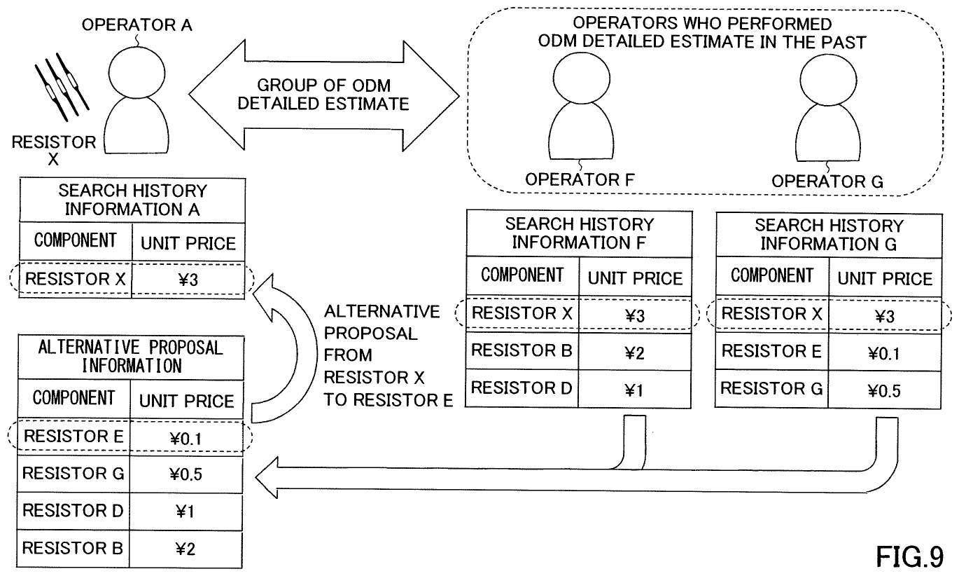

In the above explanation, although the attribute of the operator A has been determined, the same mechanism can be used to determine operators other than the operator A similar to the operator A with high accuracy by determining the attribute of each of the other operators based on the log information about the other operators. Selection examples of alternative component candidates according to the purpose of the search by the operator A that is performed through learning of the collaborative filtering will be explained with reference to FIG. 7, FIG. 8, and FIG. 9.

FIG. 7 is a drawing for explaining component selection criteria when an attribute is the proposal type EMS approximate estimate. In FIG. 7, for example, it is assumed that the operator A, whose purpose of the search is determined to be the proposal type EMS approximate estimate as explained with reference to FIG. 4, performs the search with the search condition 3. In a case where the attribute is the proposal type EMS approximate estimate, a component that has been searched for the highest number of times is selected as the alternative component candidate from the component information 5 searched by operators other than the operator A.

In a case where the attribute is the proposal type EMS approximate estimate, the number of times the component “resistor X” designated in the search condition 3 is searched by the operator A is obtained by referring to the log information. The search history information A indicates that the number of times the component “resistor X” is searched is three times.

Next, based on the log information, an operator B and an operator C who have searched the component “resistor X” are identified from among the other operators 1 who have the attribute of the proposal type EMS approximate estimate that is the same as the attribute of the operator A. Furthermore, the search history information B about the operator B and the search history information C about the operator C are generated on the basis of the log information.

The search history information B indicates that the operator B searched the component “resistor X” for five times, the “resistor B” twice, and the “resistor D” for eight times. The search history information C indicates that the operator C searched the component “resistor X” for three times, the “resistor E” for four times, and the “resistor G” for three times.

The alternative proposal information is generated by unifying the search history information B and the search history information C. The alternative proposal information shows, as a list, the component “D”, the component “E”, the component “G”, and the component “B” searched by the operator B and the operator C other than the component “resistor X”. “8” times, “4” times, “3” times, and “2” times are associated with the component “D”, the component “E”, the component “G”, and the component “B”, respectively.

The component “resistor D” searched for the highest number of times is selected from alternative proposal information and presented to the terminal of the operator A as an alternative proposal substituting for the component “resistor X” designated in the search condition 3. For reference, the component “E”, the component “G”, and the component “B” may be presented in the descending order of the number of searches.

FIG. 8 is a drawing for explaining component selection criteria in a case where an attribute is the proposal type EMS detailed estimate. In FIG. 8, for example, it is assumed that the operator A whose attribute is determined to be the proposal type EMS detailed estimate as explained with reference to FIG. 5 performs a search with the search condition 3. In the case where the attribute is the proposal type EMS detailed estimate, components having matched series are identified, as the alternative component candidate, from among information about components searched by the other operators 1 other than the operator A.

In a case where the attribute is the proposal type EMS detailed estimate, the operator D and the operator E who have searched in the past the component “resistor X”, which is designated in the search condition 3 by the operator A, are identified in the log information from among the other operators 1 other than the operator A. The operator D and the operator E have the attribute of the proposal type EMS detailed estimate that is the same as the attribute of the operator A. Further, the search history information D about the operator D and the search history information E about the operator E are generated on the basis of the log information. In the search history information D and the search history information E, the series are indicated in association with the respective components searched in the past.

The search history information D indicates that the operator D has searched the component “resistor X” in the series “MMD”, the component “resistor B” in the series “MMD”, and the component “resistor D” in the series “MDG”. The search history information E indicates that the operator E have searched the component “resistor X” in the series “MMD”, the component “resistor E” in the series “MDC”, and the component “resistor G” in the series “MDA”.

The alternative proposal information is generated by unifying the search history information D and the search history information E. In a case where the attribute is the proposal type EMS detailed estimate, the alternative proposal information includes components and series. In this example, the alternative proposal information indicates, from among the components searched by the operator D and the operator E, the component “resistor B” of which the series matches the series “MMD” of the component “resistor X” designated in the search condition 3.

Therefore, the component “resistor B” is presented to the terminal of the operator A as an alternative proposal substituting for the component “resistor X” designated in the search condition 3.

FIG. 9 is a drawing for explaining component selection criteria in a case where the attribute is the ODM detailed estimate. In FIG. 9, for example, it is assumed that the operator A whose attribute is determined to be the ODM detailed estimate as explained with reference to FIG. 6 performs a search with the search condition 3. In the case where the attribute is the ODM detailed estimate, a component of which unit price is the least expensive is preferentially selected, as the alternative component candidate, from among information about components searched by the other operators 1 other than the operator A.

In the case where the attribute is the ODM detailed estimate, the operator F and the operator G who have searched in the past the component “resistor X”, which is designated in the search condition 3 by the operator A, are identified in the log information from among the other operators 1 other than the operator A. The operator F and the operator G have the attribute of the proposal type EMS detailed estimate that is the same as the attribute of the operator A. Further, the search history information F about the operator F and the search history information G about the operator G are generated on the basis of the log information. In the search history information F and the search history information G, the unit prices are indicated in association with the respective components searched in the past.

The search history information F indicates that the operator F has searched the component “resistor X” at the unit price “3 Yen”, the component “resistor B” at the unit price “2 Yen”, and the component “resistor D” at the unit price “1 Yen”. The search history information G indicates that the operator G has searched the component “resistor X” at the unit price “3 Yen”, the component “resistor E” at the unit price “0.1 Yen”, and the component “resistor G” at the unit price “0.5 Yen”.

The alternative proposal information is generated by unifying the search history information F and the search history information G. In the case where the attribute is the proposal type EMS detailed estimate, the alternative proposal information includes components and unit prices. The alternative proposal information shows, as a list, the component “E”, the component “G”, the component “D”, and the component “B” searched by the operator F and the operator G other than the component “resistor X”. “0.1 Yen”, “0.5 Yen”, “1 Yen”, and “2 Yen” are associated with the component “E”, the component “G”, the component “D”, and the component “B”, respectively.

In this example, the component “resistor E” of which the unit price is the least expensive is selected in the alternative proposal information from among the components searched by the operator F and the operator G, and is presented to the terminal of the operator A as the alternative proposal substituting for the component “resistor X” designated in the search condition 3.

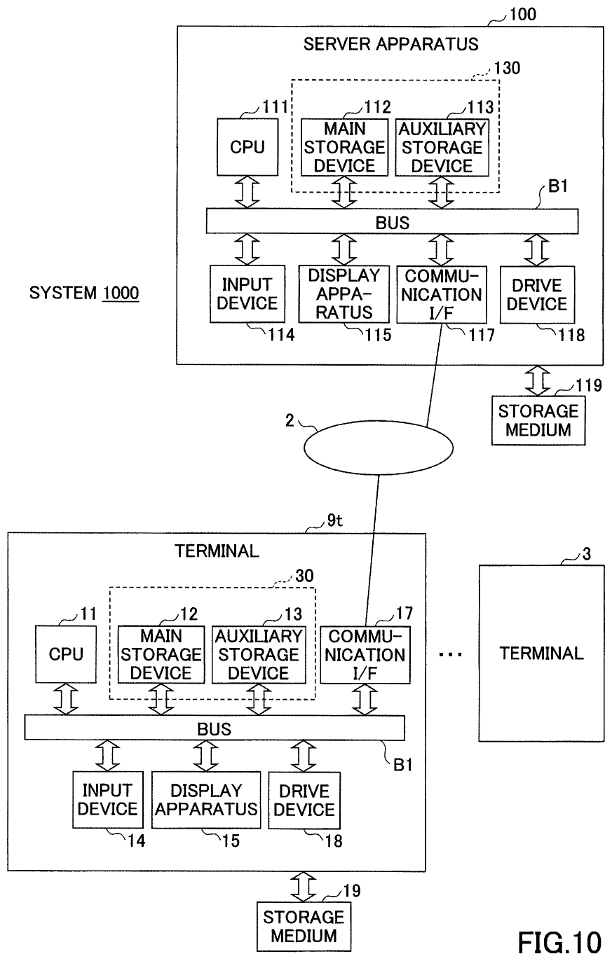

Hereinafter, a system configuration example for determining the component selection criteria will be explained. FIG. 10 is a drawing illustrating a system configuration example. A system 1000 illustrated in FIG. 10 includes a terminal 9t and a server apparatus 100. The server apparatus 100 and the terminal 9t can communicate via a network.

The server apparatus 100 is an information processing apparatus controlled by a computer, and includes a CPU (Central Processing Unit) 111, a main storage device 112, an auxiliary storage device 113, an input device 114, a display apparatus 115, a communication I/F (interface) 117, and a drive device 118. The server apparatus 100 is connected to a bus B1.

The CPU 111 corresponds to a processor that controls the server apparatus 100 according to a program stored in the main storage device 112. The main storage device 112 uses a RAM (Random Access Memory), a ROM (Read Only Memory), and the like, and stores or temporarily stores data including programs.

The auxiliary storage device 113 uses an HDD (Hard Disk Drive) or the like, and stores various data including programs. A part of the program stored in the auxiliary storage device 113 is loaded into the main storage device 112 and executed by the CPU 111.

The input device 114 includes a mouse, a keyboard, and the like, and is used by a user such as an administrator of the server apparatus 100 to input information to the server apparatus 100. The display apparatus 115 displays various kinds of information. The communication I/F 117 performs communication through a wired or wireless network.

A program that realizes processing performed by the server apparatus 100 is provided to the server apparatus 100 as a storage medium 119 such as a CD-ROM (Compact Disc Read-Only Memory). The drive device 118 serves as an interface between the storage medium 119 (for example, a CD-ROM) loaded in the drive device 118 and the server apparatus 100.

It should be noted that the storage medium 119 that stores the programs is not limited to a CD-ROM, and may be one or more non-transitory, tangible media that have a computer-readable structure. The computer-readable storage medium may be not only a CD-ROM but also a DVD disk, a portable recording medium such as a USB memory, or a semiconductor memory such as a flash memory.

The terminal 9t is an information processing terminal controlled by a computer, and includes a CPU (Central Processing Unit) 11, a main storage device 12, an auxiliary storage device 13, an input device 14, a display apparatus 15, a communication I/F (interface) 17, and a drive device 18. The terminal 9t is connected to a bus B2.

The CPU 11 corresponds to a processor that controls the terminal 9t according to a program stored in the main storage device 112. The main storage device 12 uses a RAM (Random Access Memory), a ROM (Read Only Memory), and the like, and stores or temporarily stores data including programs.

The auxiliary storage device 13 uses an HDD (Hard Disk Drive) or the like, and stores various data including programs. A part of the program stored in the auxiliary storage device 13 is loaded into the main storage device 12 and executed by the CPU 11.

The input device 14 includes a mouse, a keyboard, and the like, and is used by a user such as an administrator of the terminal 9t to input information to the terminal 9t. The display apparatus 15 displays various kinds of information. The communication I/F 17 performs communication through a wired or wireless network. The input device 14 and the display apparatus 15 may be an integrated touch panel.

A program that realizes processing performed by the terminal 9t is provided to the terminal 9t as a storage medium 19 such as a CD-ROM (Compact Disc Read-Only Memory). The drive device 18 serves as an interface between the storage medium 19 (for example, a CD-ROM) loaded in the drive device 18 and the terminal 9t.

It should be noted that the storage medium 19 that stores the programs is not limited to a CD-ROM, and may be one or more non-transitory, tangible media that have a computer-readable structure. The computer-readable storage medium may be not only a CD-ROM but also a DVD disk, a portable recording medium such as a USB memory, or a semiconductor memory such as a flash memory.

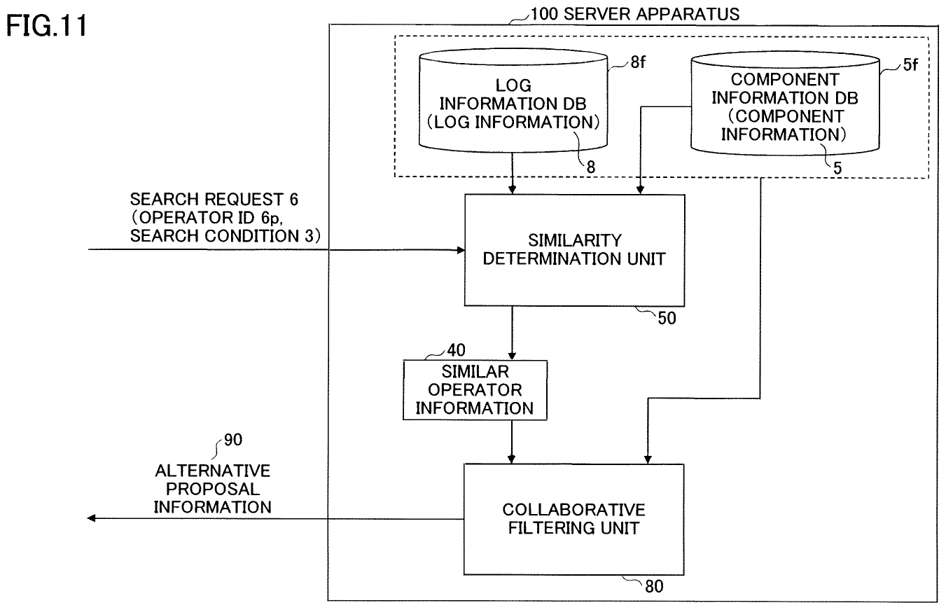

FIG. 11 is a drawing illustrating a functional configuration example of a server apparatus. In FIG. 11, the server apparatus 10 mainly includes a similarity determination unit 50 and a collaborative filtering unit 80. The similarity determination unit 50 and the collaborative filtering unit 80 are implemented by the CPU ill executing corresponding programs. A storage unit 130 stores an operator ID, a search condition 3, component information DB 5f including component information 5, log information DB 8f including log information 8, similar operator information 40, alternative proposal information 90, and the like.

The similarity determination unit 50 refers to the component information DB 5f and the log information DB 8f in accordance with the search request 6 including the operator ID, the search condition 3, and the like, determines the attribute of the operator A of the requesting terminal 9t, and generates similar operator information 40 identifying another operator 1 having the same attribute. The similar operator information 40 is stored in the storage unit 130. In the present embodiment, one of the proposal type EMS approximate estimate, the proposal type EMS detailed estimate, and the ODM detailed estimate, which are the search purpose, is given as the attribute of the operator 1.

The collaborative filtering unit 80 refers to the similar operator information 40 generated by the similarity determination unit 50, and generates alternative proposal information 90 indicating an alternative proposal corresponding to a search purpose (i.e., an estimate type) according to component selection criteria determined by the similarity determination unit 50. The alternative proposal information 90 is transmitted to the requesting terminal 9t by the communication I/F 117. The collaborative filtering unit 80 corresponds to an example of an alternative proposal information generation unit for proposing replacement of an original component with another component from the viewpoint of proposing another component substituting for the original component designated in the search condition 3.

As explained with reference to FIG. 7, FIG. 8, and FIG. 9, in a case where the attribute of the operator A of the requesting terminal 9t is the “proposal type EMS approximate estimate”, the component selection criteria is “the number of times of searches is the highest”. In a case where the attribute of the operator A of the requesting terminal 9t is “proposal type EMS detailed estimate”, the component selection criteria is “series match”. In a case where the attribute of the operator A of the requesting terminal 9t is “ODM detailed estimate”, the component selection criteria is “low price”.

In the present embodiment, the collaborative filtering unit 80 uses the log information DB 8f and the component information DB 5f to perform search according to the component selection criteria corresponding to the search purpose (i.e., the estimate type). Also, after providing the alternative proposal information 90, the collaborative filtering unit 80 accumulates the component information 5 referred to by the operator A into the log information DB 8f.

In the present embodiment, since the range of the operators 1 searched by the collaborative filtering unit 80 can be narrowed down by providing the similarity determination unit 50, the component information 5 that matches the purpose of the component search performed by the operator A can be provided with high accuracy. Hereinafter, an operator 1 who is to be identified as an operator that performed a search request will be referred to as an operator A.

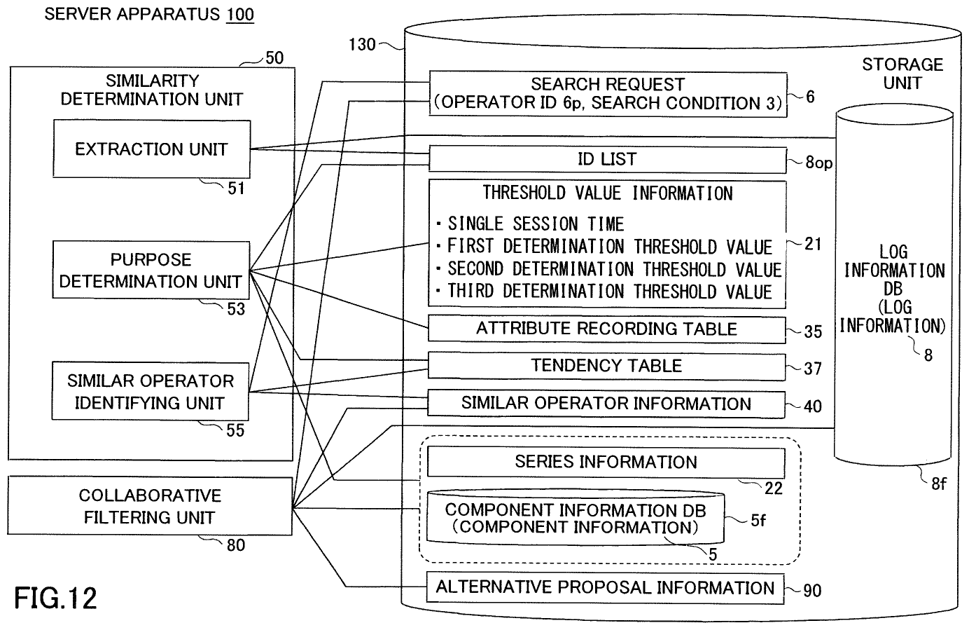

FIG. 12 is a drawing illustrating a detailed example of a functional configuration of the server apparatus. As illustrated in FIG. 12, the similarity determination unit 50 includes an extraction unit 51, a purpose determination unit 53, and a similar operator identifying unit 55. The extraction unit 51, the purpose determination unit 53, and the similar operator identifying unit 55 are implemented by the CPU 111 executing corresponding programs. As information related to similarity determination processing performed by the similarity determination unit 50, the storage unit 130 stores a search request 6, the component information DB 5f, the log information DB 8f, an ID list 8op, threshold value information 21, series information 22, an attribute recording table 35, a tendency table 37, similar operator information 40, and the like.

The extraction unit 51 obtains all the operator IDs from the log information DB 8f in response to reception of the search request 6, and stores the ID list 8op in the storage unit 130. The search request 6 includes the operator ID 6p, the search condition 3, and the like. The search request 6 is stored in the storage unit 130.

For each of the operators 1 identified by the operator ID in the ID list 8op, the purpose determination unit 53 obtains the log information 8 from the log information DB and determines the attribute of each of the operators 1 in a unit of a single session time (hereinafter referred to as a unit of session) of the threshold value information 21. The attribute of each of the operators 1 is determined in the unit of session, and the attribute recording table 35 indicating the determination result is stored in the storage unit 130.

In a case where information about series does not exist in the log information 8, the purpose determination unit 53 identifies the series by referring to the series information 22 using the information about the component in the log information 8. In a case where information about specifications does not exist in the log information 8, the purpose determination unit 53 identifies the specifications by referring to the component information DB 5f using the information about the component in the log information 8.

For each of the sessions of the operators 1, the purpose determination unit 53 obtains the first log information 8 as the criteria information 9 to perform the first determination, and in a case where the estimate type is not identified as a result of the first determination, the purpose determination unit 53 performs the second determination and the third determination.

In the first determination (determination of the proposal type EMS approximate estimate), records indicating unit prices higher than the unit price indicated in the criteria information 9 are counted. In a case where a first ratio of the number of counted records with respect to the total number of records in the session is equal to or more than the first determination threshold value of the threshold value information 21, the proposal type EMS approximate estimate is determined as the attribute of the operator 1 in the session.

In a case where the first ratio is less than the first determination threshold value, the second determination is performed. In the second determination, a number of records other than the criteria information 9 where the series match the series indicated in the criteria information 9 (hereinafter referred to as series matching number) is counted. In a case where the second ratio of the counted series matching number with respect to the total number of records in the session is less than the second determination threshold value, the purpose of the search is determined to correspond to none of the estimate types.

In a case where the second ratio is equal to or more than the second determination threshold value of the threshold value information 2, the third determination is further performed. In the third determination, for one or more items of specifications indicated in the criteria information 9, a number of items in records other than the criteria information 9 in the session where the specifications match the specifications indicated in the criteria information 9 (hereinafter referred to as specification matching number) is counted. In a case where a third ratio of the counted specification matching number with respect to the total number of items of the specifications in the records in the session is equal to or more than the third determination threshold value, the proposal type EMS detailed estimate is determined as the attribute of the operator 1 in the session. In a case where the third ratio is less than the third determination threshold value, the ODM detailed estimate is determined as the attribute of the operator 1 in the session.

Furthermore, for each of the operators 1, the purpose determination unit 53 determines the attribute of the operator 1 in a predetermined period including multiple sessions for the records in the attribute recording table 35 in which the attribute is indicated in the unit of session.

The attribute of the operator A who has requested the search is also determined by determining the attribute of the operator 1. In other words, determining the attribute of the operator A corresponds to determining the component selection criteria. From such viewpoint, the purpose determination unit 53 corresponds to an example of a determination unit for determining the component selection criteria.

The similar operator identifying unit 55 refers to the tendency table 37 obtained by the purpose determination unit 53 to identify other operators 1 of which characteristics match the characteristics of the operator A identified by the operator ID 6p of the search request 6. The storage unit 130 stores the similar operator information 40 indicating at least the operator ID of the other operators 1 identified. The similar operator information 40 includes one or more operator IDs.

In the above explanation, regardless of the reception of the search request 6, the extraction unit 51 and the purpose determination unit 53 may execute the above processing with a predetermined time interval to update the tendency table 37. Although the above processing is performed in response to reception of the search request 6, the processing performed by the extraction unit 51 and the purpose determination unit 53 may be omitted as long as a predetermined period of time has not yet passed since the tendency table 37 was last updated.

The collaborative filtering unit 80 refers to the log information DB 8t to learn the log information 8 about the operator A identified by the operator ID of the search request 6 and the log information 8 about the operator 1 identified by the similar operator information 40, and determines a component presented as an alternative proposal. The collaborative filtering unit 80 is given with the similar operator information 40, and determines the component to be presented as the alternative proposal as explained with reference to FIG. 7 to FIG. 9 through learning. The alternative proposal information 90 including the component information 5 obtained by the collaborative filtering unit 80 is transmitted to the terminal 9t of the operator A who has requested the search.

In a case where information about series does not exist in the log information 8 about the operator 1 identified by the similar operator information 40, the collaborative filtering unit 80 identifies the series by referring to the series information 22 using the information about the component in the log information 8. In a case where information about specifications does not exist in the log information 8, the collaborative filtering unit 80 identifies the specifications by referring to the component information DB 5f using the information about the component in the log information 8.

The alternative proposal information 90 may include component information 5 about a best recommended component, and may include multiple pieces of component information 5 sorted in the order of the recommendation.

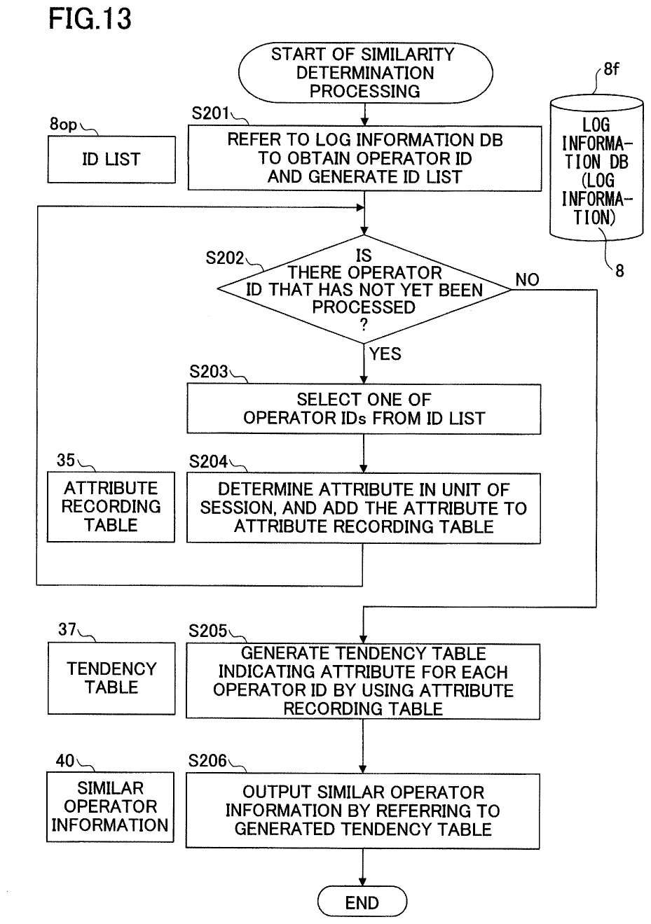

Next, the similarity determination processing by the similarity determination unit 50 will be explained. FIG. 13 is a flowchart for explaining an outline of similarity determination processing. In FIG. 13, in the similarity determination unit 50, the extraction unit 51 refers to the log information DB 8f to obtain the operator ID and generates the ID list 8op (step S201). The generated ID list 8op is stored in the storage unit 130.

Next, the purpose determination unit 53 performs the purpose determination processing for determining the attribute of each session for each of the operator IDs. The purpose determination processing corresponds to step S202 to step S204. In the following explanation, the purpose determination processing is performed on the log information 8 from which components have been searched.

The purpose determination unit 53 determines whether the ID list 8op includes an unprocessed operator ID (step S202). In a case where the ID list 8op includes an unprocessed operator ID (YES in step S202), the purpose determination unit 53 selects an operator ID from the ID list 8op (step S203).

Then, with regard to the selected operator ID, the purpose determination unit 53 determines the attribute in the unit of session, and adds the attribute to the attribute recording table 35 (step S204), and returns back to step S202.

In a case where the ID list 8op does not include any unprocessed operator ID (NO in step S202), the purpose determination unit 53 performs similar operator identifying processing for identifying an operator 1 similar to the operator A identified in the search request 6 by the similar operator identifying unit 55. The similar operator identifying processing corresponds to step S205 and S206.

The similar operator identifying unit 55 generates the tendency table 37 indicating the attribute for each of the operator IDs by using the attribute recording table 35 (step S205). By referring to the generated tendency table 37, the similar operator identifying unit 55 outputs the similar operator information 40 indicating the operator ID of another operator 1 who has the attribute of the operator A (step S206). The similar operator information 40 includes one or more operator IDs.

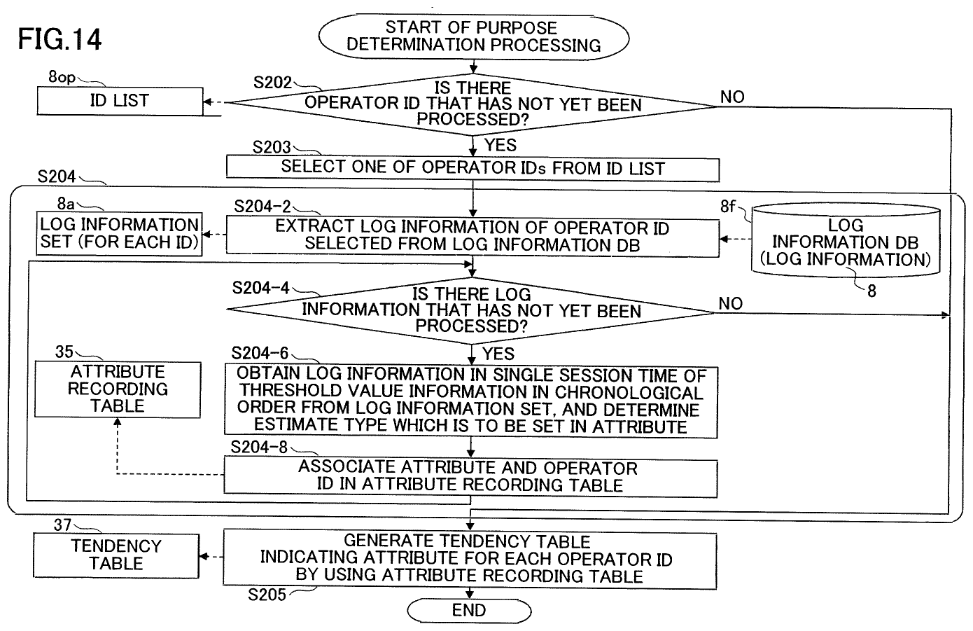

FIG. 14 is a flowchart for explaining purpose determination processing. The purpose determination processing corresponds to the processing in step S202 to 5205 of FIG. 13. In FIG. 14, the purpose determination unit 53 determines whether the ID list 8op includes an unprocessed operator ID or not (step S202). In a case where the ID list 8op does not include any unprocessed operator ID (NO in step S202), the purpose determination unit 53 proceeds to step S205. Steps S205 and S206 are as described in FIG. 13, and therefore, explanation thereabout is omitted here.

In a case where the ID list 8op includes an unprocessed operator ID (YES in step S202), the purpose determination unit 53 selects an operator ID from the ID list 8op (step S203), and performs session-specific attribute determination processing for determining the attribute for each session by performing step S204.

In step S204, the purpose determination unit 53 extracts the log information 8 of the operator ID selected from the log information DB 8f, and generates log information set 8a (step S204-2). The log information set 8a is stored in the storage unit 130.

The purpose determination unit 53 determines whether the log information set 8a includes log information 8 or not (step S204-4). In a case where the log information set 8a includes log information 8 (NO in step S204-4), the purpose determination unit 53 terminates the session-specific attribute determination processing, and proceeds to step S205.

In a case where the log information set 8a includes log information 8 (step S204-YES), the purpose determination unit 53 obtains the log information 8 in the single session time of the threshold value information 21 in chronological order from the log information set 8a, and determines the estimate type which is to be set in the attribute (step S204-6). The purpose determination unit 53 associates the attribute for each unit of session with the operator ID and records the associated attribute and operator ID in the attribute recording table 35 (step S204-8), and returns back to step S204-4 to repeat processing similar to the above.

When the processing is finished for all of the operator IDs in the log information set 8a, the purpose determination unit 53 selects the most frequent attribute for each of the operator IDs on the basis of the attributes in the unit of session in the attribute recording table 35, thereby generating the tendency table 37 indicating the attribute for each of the operator IDs, and then terminates this purpose determination processing (step S205). The generated tendency table 37 is stored in the storage unit 130.

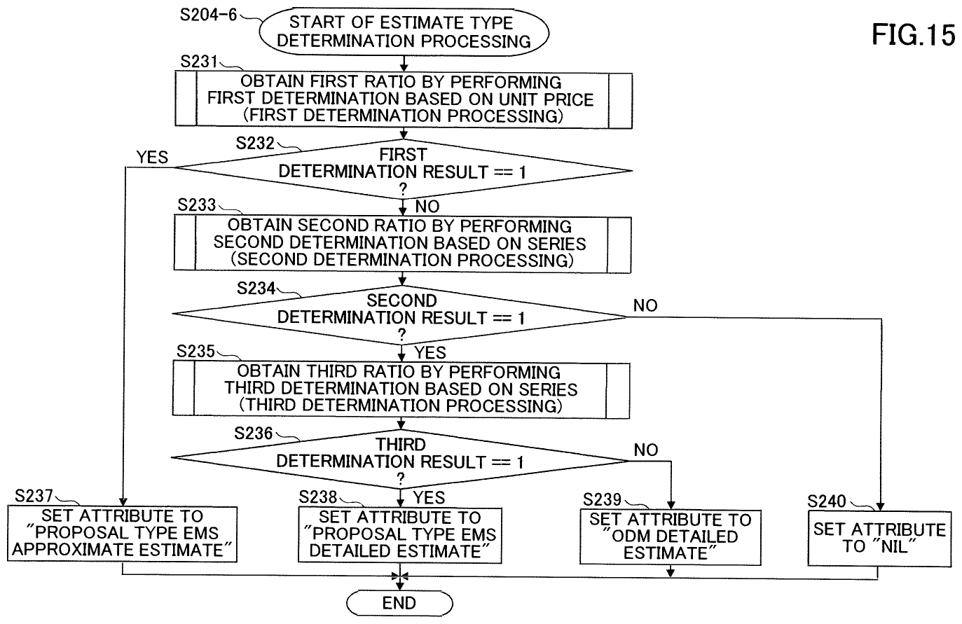

FIG. 15 is a flowchart for explaining estimate type determination processing performed in step S204-6 of FIG. 14. In FIG. 15, the first determination, the second determination, and then the third determination explained in FIG. 3 are performed to determine the estimate type that is set for the attribute of the operator 1.

First, the purpose determination unit 53 executes the first determination processing for obtaining the first ratio by performing the first determination on the basis of the unit price (step S231). The first determination processing will be explained later. The purpose determination unit 53 determines whether the first determination result yielded in the first determination processing indicates 1 (positive result) or not (step S232). In a case where the first determination result is 1 (YES in step S232), the purpose determination unit 53 sets the attribute to “proposal type EMS approximate estimate” (step S237), and terminates this estimate type determination processing.

In a case where the first determination result is not 1 (negative result) (NO in step S232), the purpose determination unit 53 executes the second determination processing for obtaining the second ratio by performing the second determination on the basis of the series (step S233). The second determination processing will be explained later. The purpose determination unit 53 determines whether the second determination result indicates 1 (positive result) or not (step S234).

In a case where the second determination result is 1 (YES in step S234), the purpose determination unit 53 further executes the third determination processing for obtaining the third ratio by performing the third determination on the basis of the specifications (step S235). The third determination processing will be explained later. The purpose determination unit 53 determines whether the third determination result indicates 1 (positive result) or not (step S236).

In a case where the third determination result is 1 (YES in step S236), the purpose determination unit 53 sets the attribute to “proposal type EMS detailed estimate” (step S238), and terminates this estimate type determination processing.

In a case where the third determination result is not 1 (negative result) (NO in step S236), the purpose determination unit 53 sets the attribute to “ODM detailed estimate” (step S239), and terminates this estimate type determination processing.

Further, in a case where the second determination result is not 1 (negative result) (NO in step S234), the purpose determination unit 53 sets the attribute to “NIL” (step S240), and terminates this estimate type determination processing.

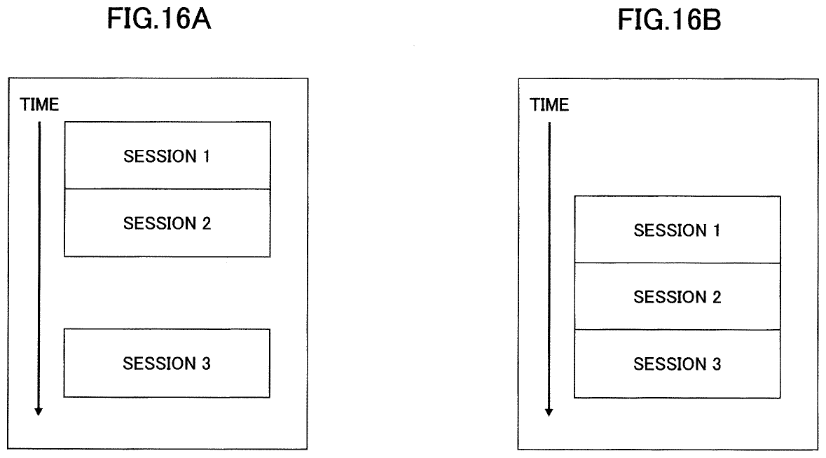

FIGS. 16A and 16B are drawings for explaining sessions according to the present embodiment. FIGS. 16A and 16B illustrate examples in which sessions are set in session time units on the basis of presence or absence of log information 8.

FIG. 16A illustrates an example in which, for log information 8 of any given operator 1, two continuous sessions 1 and 2 and a session 3 are set according to an elapse of time. In the single session time between the session 2 and the session 3, there is no log information 8, and accordingly, no session is set.

FIG. 16B illustrates a case where, for log information 8 of any given operator 1, there is no log information 8 until the end of the single session time, but log information 8 exists in three continuous sessions subsequent thereto. In this case, the sessions 1, 2, and 3 are set.

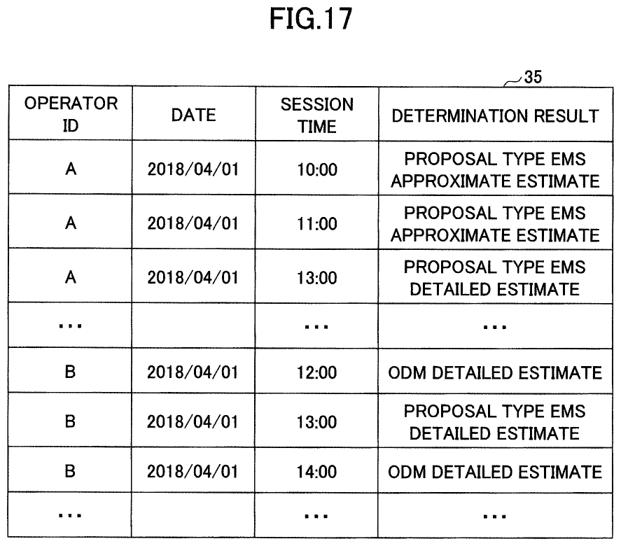

FIG. 17 is a drawing illustrating a data example of an attribute recording table in the example of FIGS. 16A and 16B. In the attribute recording table 35 indicated in FIG. 17, the single session time is assumed to be one hour, and an example of determination results for the sessions is shown. The attribute recording table 35 is a table illustrating a date, a session time, a determination result of an estimate type (attribute), and the like for each of the operators, and includes items such as an operator ID, a date, a session time, a determination result, and the like.

The operator ID indicates identification information that identifies the operator. The date indicates a year, a month, and a day. The session time indicates a start time of a session in which log information 8 exists. The determination result indicates an estimated type that was determined as the attribute.

The example of the attribute recording table 35 illustrated in FIG. 17 indicates that, for the operator having the operator ID “A” (hereinafter referred to as an operator A), a determination result in a session of one hour starting from “10:00” is “proposal type EMS approximate estimate”. The example of the attribute recording table 35 also indicates that a determination result in a session of one hour starting from “11:00” is “proposal type EMS approximate estimate”.

In one hour subsequent thereto, it is assumed that log information 8 does not exist, and thereafter, a determination result “proposal type EMS detailed estimate” in a session of one hour starting from “13:00” is recorded. Thereafter, a determination result is indicated for each session in which log information 8 exists.

Further, the example of the attribute recording table 35 illustrated in FIG. 17 indicates that, for an operator having an operator ID “B” (hereinafter referred to as an operator B), a determination result in a session of one hour starting from “12:00” is “ODM detailed estimate”. The example of the attribute recording table 35 also indicates that a determination result in a session of one hour starting from “13:00” is “proposal type EMS detailed estimate”, and further, a determination result in a session of one hour starting from “14:00” is “ODM detailed estimate”. For the operators A, B, and the like, recordings are similarly made for dates other than the date “2018/04/01”.

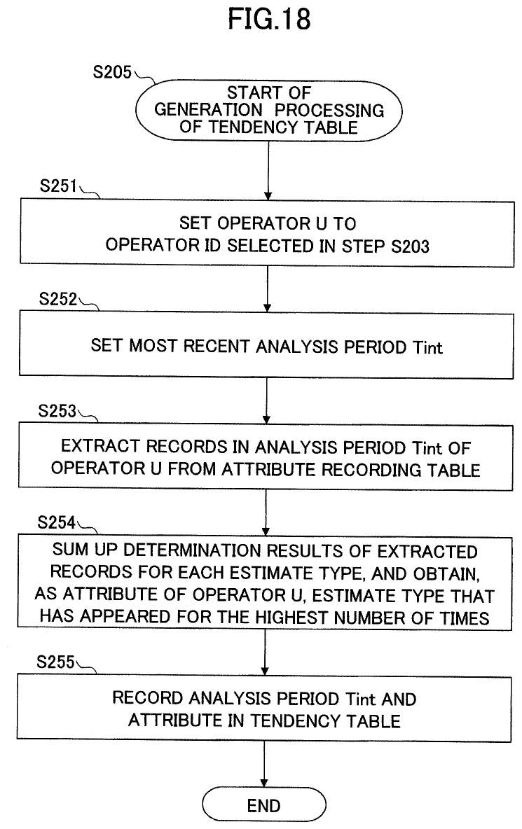

The attribute recording table 35 accumulates determination results in the past, but the data example of the attribute recording table 35 illustrated in FIG. 17 is assumed to be recordings in the most recent analysis period (for example, one day), and determination results of the attributes in the most recent predetermined period for each of the operators 1 will be explained in FIG. 18. The analysis period is not limited to 1 day. The analysis period may be set as appropriate, such as, e.g., 1 year, 1 month, several months, 1 week, several days, several hours, and the like.

FIG. 18 is a drawing for explaining generation processing of a tendency table in step S205 of FIG. 13 and FIG. 14. In FIG. 18, the purpose determination unit 53 sets an operator U to the operator ID selected in step S203 (FIG. 13, FIG. 14) (step S251), and sets a most recent analysis period Tint (step S252).

The purpose determination unit 53 extracts records in the analysis period Tint of the operator U from the attribute recording table 35 (step S253). Then, for each estimate type, the purpose determination unit 53 sums up the determination results of the extracted records, and obtains, as the attribute of the operator U, the estimate type that has appeared for the highest number of times (step S254).

Then, the purpose determination unit 53 records the analysis period Tint and the attribute in the tendency table 37 (step S255), and terminates the generation processing of the tendency table 37.

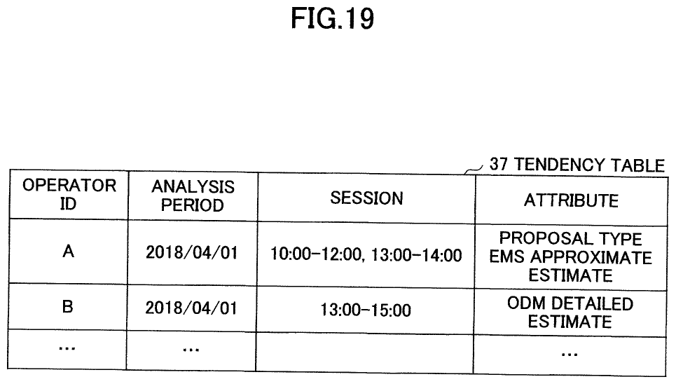

FIG. 19 is a figure illustrating a data example of a tendency table. In FIG. 19, the tendency table 37 is a table indicating attributes in the analysis period for each of the operators, and includes items such as an operator ID, an analysis period, a session, an attribute, and the like.

The operator ID indicates identification information of an operator. The analysis period indicates a most recent analysis period, and is, for example, 1 year, 1 month, several months, 1 week, several days, several hours, and the like. This example indicates a date in a case where one day is the target of the analysis period, but the analysis period is an item that can be omitted. The session is a time period in the analysis period in which log information 8 exists and a session is set. The attribute indicates an estimate type of the operator 1 determined in the analysis period.

This data example indicates that, for the operator A, in an analysis period “2018/04/01”, time periods based on sessions in which log information 8 exists are “10:00-12:00, 13:00-14:00”, and the attribute is “proposal type EMS approximate estimate”.

This data example indicates that, for the operator B, in the same analysis period, a time period based on a session in which log information 8 exists is “13:00-15:00”, and the attribute is “ODM detailed estimate”.

In the above example, time periods based on sessions in which log information 8 exists are indicated in the item “session”. However, the item “session” may simply indicate the number of sessions.

Next, the details of the processing of steps S231, S233, and S235 in FIG. 15 will be explained. First, the first determination processing for determining “proposal type EMS approximate estimate” based on a unit price in step S231 will be explained.

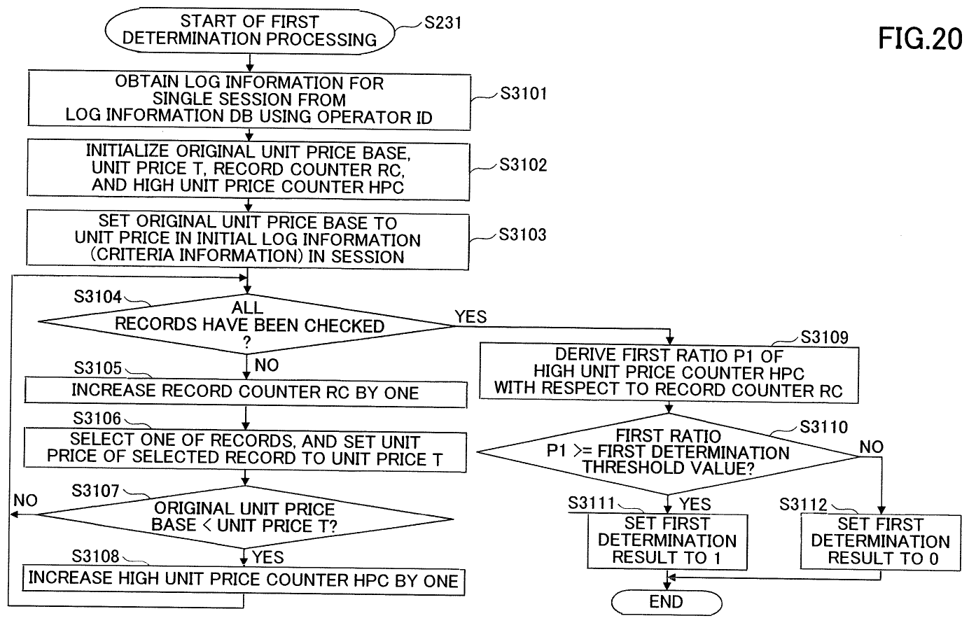

FIG. 20 is a flowchart for explaining first determination processing in step S231 of FIG. 15. In FIG. 20, the purpose determination unit 53 obtains log information 8 for a single session from the log information DB 8f using the operator ID (step S3101), and initializing an original unit price BASE, a unit price T, a record counter RC, and a high unit price counter HPC by setting them to zero (step S3102). Also, the purpose determination unit 53 sets an original unit price BASE to a unit price in initial log information (criteria information 9) in the session (step S3103).

Then, the purpose determination unit 53 determines whether all the records obtained in step 53101 have been checked or not (step S3104). In a case where there is a record that has not yet been checked (NO in step S3104), the purpose determination unit 53 increases the record counter RC by one (step S3105), and selects one of the records that has not yet been checked, and sets the unit price of the selected record to the unit price T (step S3106).

The purpose determination unit 53 determines whether the original unit price BASE is less than the unit price T, and more specifically, determines whether the unit price T is higher than the original unit price BASE (step S3107). In a case where the original unit price BASE is less than the unit price T (YES in step S3107), the purpose determination unit 53 increases the high unit price counter HPC by one (step S3108), and returns back to step S3104 to repeat processing similar to the above. In a case where the original unit price BASE is equal to or more than the unit price T, the purpose determination unit 53 returns back to step S3104 to repeat processing similar to the above, without increasing the high unit price counter HPC by one.

In a case where all the records have been checked (YES in step S3104), the purpose determination unit 53 derives a first ratio P1 of the high unit price counter HPC with respect to the record counter RC (step S3109). For example, the first ratio P1 may be calculated by:

P1=HPC/RC×100.

The purpose determination unit 53 determines whether the first ratio P1 is equal to or more than the first determination threshold value (step S3110). For example, the first determination threshold value is 15% and the like. In a case where the first ratio P1 is equal to or more than the first determination threshold value (YES in step S3110), the purpose determination unit 53 sets the first determination result to 1 (step S3111), and terminates this first determination processing. In a case where the first ratio P1 is less than the first determination threshold value (NO in step S3110), the purpose determination unit 53 sets the first determination result to zero (step S3112), and terminates this first determination processing.

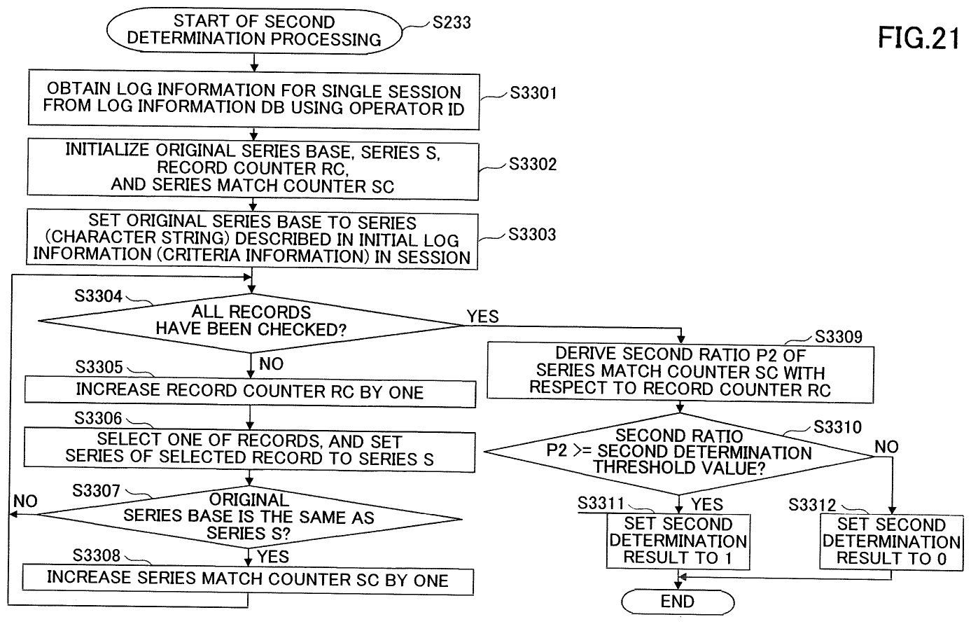

FIG. 21 is a flowchart for explaining second determination processing in step S233 of FIG. 15. In FIG. 21, the purpose determination unit 53 obtains log information 8 for a single session from the log information DB 8f using the operator ID (step S3301), and sets an original series B and a series S to null and sets the record counter RC and the series match counter SC to zero to initialize them (step S3302). Also, the purpose determination unit 53 sets the original series BASE to a series described in initial log information (criteria information 9) in the session (step S3303). The original series BASE is set to a character string.

Then, the purpose determination unit 53 determines whether all the records obtained in step S3301 have been checked or not (step S3304). In a case where there is a record that has not yet been checked (NO in step S3304), the purpose determination unit 53 increases the record counter RC by one (step S3305), and selects one of the records that has not yet been checked, and sets the series S to the series of the selected record (step S3306).

The purpose determination unit 53 determines whether the original series BASE is the same as the series S (step S3307). In a case where the original series BASE is the same as the series S (YES in step S3307), the purpose determination unit 53 increases the series match counter SC by one (step S3308), and returns back to step S3304 to repeat processing similar to the above. In a case where the original series BASE is not the same as (i.e., different from) the series S, the purpose determination unit 53 returns back to step S3304 to repeat processing similar to the above, without increasing the series match counter S by one.

In a case where all the records have been checked (YES in step S3304), the purpose determination unit 53 derives a second ratio P2 of the series match counter SC with respect to the record counter RC (step S3309). For example, the second ratio P2 may be calculated by:

P2=SC/RC×100.

The purpose determination unit 53 determines whether the second ratio P2 is equal to or more than the second determination threshold value (step S3310). For example, the second determination threshold value is 50% and the like. In a case where the second ratio P2 is equal to or more than the second determination threshold value (YES in step S3310), the purpose determination unit 53 sets the second determination result to 1 (step S3311), and terminates this second determination processing. On the other hand, in a case where the second ratio P2 is less than the second determination threshold value (NO in step S3310), the purpose determination unit 53 sets the second determination result to zero (step S3312), and terminates this second determination processing.

As the determination method for determining the same series in step S3307, typically, a start-with matching method of a model name of a manufacturer may be used. A prefix may be matched by using a database including similar model names of manufacturers. There are various matching methods, and any one of them may be used.

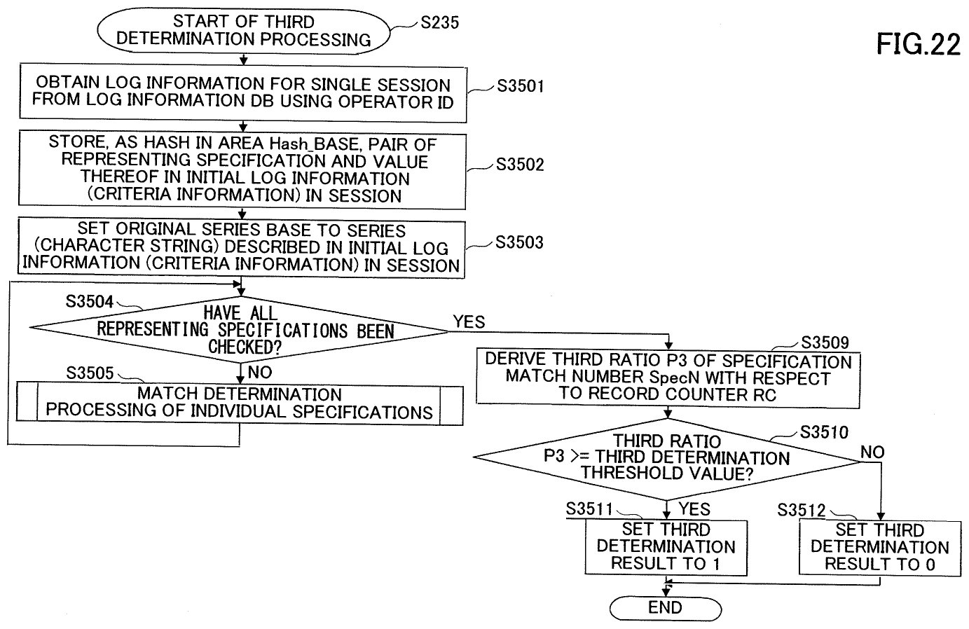

FIG. 22 is a flowchart for explaining third determination processing in step S235 of FIG. 15. In FIG. 22, the purpose determination unit 53 obtains the log information 8 for the single session from the log information DB 8f using the operator ID (step S3501).

Next, the purpose determination unit 53 stores, as a hash in an area Hash_BASE, a pair of a representing specification and a value thereof in the initial log information (criteria information) in the session (step S3502). Also, the purpose determination unit 53 sets a record counter RC and a specification match number SpecN to zero, sets a representing specification SpecD to null, and sets a value V to perform initialization (step S3503).

Then, the purpose determination unit 53 determines whether all the representing specifications have been checked or not (step S3504). In a case where an unchecked representing specification exists (NO in step S3504), the purpose determination unit 53 performs the match determination processing of individual specifications (step S3505), and returns to step S3504 to repeat processing similar to the above. The representing specification corresponds to an item name of the specification, and the individual specification corresponds to a value of the representing specification. In the match determination processing of the individual specifications, a number of matching pairs of the representing specifications and individual specifications is counted.

In a case where all the representing specifications have been checked (YES in step S3504), the purpose determination unit 53 derives a third ratio P3 of the specification match number SpecN with respect to the record counter RC (step S3509). For example, the third ratio P3 can be derived by:

P3=SpecN/RC×100.

The purpose determination unit 53 determines whether the third ratio P3 is equal to or more than the third determination threshold value (step S3510). For example, the third determination threshold value is 50% and the like. In a case where the third ratio P3 is equal to or more than the third determination threshold value (YES in step S3510), the purpose determination unit 53 sets the third determination result to one (step S3511), and terminates this third determination processing. On the other hand, in a case where the third ratio P3 is less than the third determination threshold value (NO in step S3510), the purpose determination unit 53 sets the third determination result to zero (step S3512), and terminates this third determination processing.

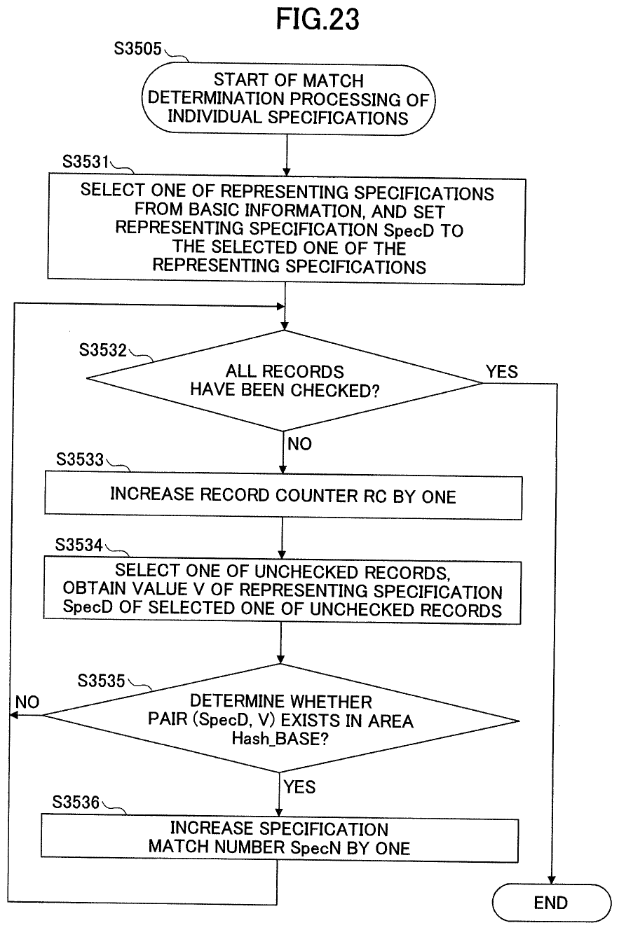

FIG. 23 is a flowchart for the explaining match determination processing of individual specifications in step S3505 of FIG. 22. In FIG. 23, the purpose determination unit 53 selects one of the representing specifications from the basic information, and sets the representing specification SpecD to the selected one of the representing specifications (step S3531).

Then, the purpose determination unit 53 determines whether all the records obtained in step S3501 (FIG. 21) have been checked or not (step S3532). In a case where an unchecked record exists (NO in step S3532), the purpose determination unit 53 increments the record counter RC by one (step S3533).

Next, the purpose determination unit 53 selects one of the unchecked records, and obtains the value V of the representing specification SpecD of the selected one of the unchecked records (step S3534). The purpose determination unit 53 determines whether a pair (SpecD, V) exists in the area Hash_BASE or not (step S3535).

In a case where the pair (SpecD, V) exists in the area Hash_BASE (YES in step S3536), the purpose determination unit 53 increases the specification match number SpecN by one (step S3536), and returns back to step S3532 to repeat the processing similar to the above. In a case where the pair (SpecD, V) does not exist in the area Hash_BASE (NO in step S3536), the purpose determination unit 53 returns back to step S3532 to repeat the processing similar to the above, without increasing the specification match number SpecN by one.

On the other hand, in a case where all the records have been checked (YES in step S3532), the purpose determination unit 53 terminates this match determination processing of the individual specifications.

As described above, in the present embodiment, an estimate type is given as the attribute of the operator 1. Then, by giving the similar operator information 40 indicating another operator 1 having the same attribute as the operator A who has requested the search to the collaborative filtering unit 80, the search result in view of the estimate type can be presented through learning performed by the collaborative filtering unit 80.

To facilitate the learning of the collaborative filtering unit 80, the attribute (estimate type) of the operator A who gave the search request 6 may be included in the similar operator information 40 to indicate the component selection criteria. The collaborative filtering unit 80 performs the search with an emphasis placed on any one of a number of searches, a match in series, and a lower price. The collaborative filtering unit 80 refers to component information searched by operators identified by the similar operator information 40 obtained from the log information DB9f and refers to the component information DB 5f, thereby generating the alternative proposal information 90 including information about the recommended component.

Therefore, a problem of presenting component information 5 that does not match the search purpose, i.e., unnecessary component information 5, can be solved. More specifically, recommendation accuracy in the component search can be improved. In addition to these effects, the operator A who gives the search request 6 can obtain appropriate new component information 5 without inputting information other than the search condition 3, such as, e.g., information about the operator A and the search purpose. As a result, products better than expected by the operator A can be manufactured.

According to at least one embodiment of the disclosure of the present application, alternative proposal information suitable for the purpose of component search performed by an operator can be provided.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present inventions has been described in detail, it should be understood that the various changes, substitutions, and alterations could be made hereto without departing from the spirit and scope of the invention.

What is claimed is:

1. An information processing apparatus comprising:
a memory; and
a processor coupled to the memory and configured to perform:
generating, on a basis of a first component selection criteria for a first component search performed by a first operator, alternative proposal information by referring to log information about a second component search performed by a second operator with a second component selection criteria which is same as the first component selection criteria.

2. The information processing apparatus according to claim 1, wherein the processor is further configured to perform:
determining the first component selection criteria on a basis of the log information related to the first component search,
determining the second component selection criteria on a basis of the log information related to the second component search, and
generating similar operator information indicating the second operator who performs the second component search with the second component selection criteria that matches the first component selection criteria.

3. The information processing apparatus according to claim 2, wherein the first component selection criteria and the second component selection criteria depend on a first attribute of the first operator and a second attribute of the second operator, respectively, and
the first or second attribute includes an estimate type which is any one of a proposal type EMS (Electronics Manufacture Service) approximate estimate in which an ease of procurement of a component is regarded as important, a proposal type EMS detailed estimate in which a performance of a component is regarded as important, and an ODM (Original Design Manufacturing) detailed estimate in which a unit price of a component is regarded as important.

4. The information processing apparatus according to claim 3, wherein the alternative proposal information includes information proposing an alternative component in place of an original component, and
the processor is further configured to perform:
upon determining that the estimate type is the proposal type EMS approximate estimate, selecting, as the alternative component, a component that is searched by the second operator for a highest number of times,
upon determining that the estimate type is the proposal type EMS detailed estimate, selecting, as the alternative component, a component which is searched by the second operator and of which series matches a series of the original component, and
upon detecting that the estimate type is the ODM detailed estimate, selecting, as the alternative component, a component of which unit price is the lowest among components searched by the second operator.

5. The information processing apparatus according to claim 3, wherein the log information includes a plurality of records, and the record includes at least one item and,
the processor is further configured to perform, with regard to any one of the first and second operators:
a first determination for determining whether the estimate type is the proposal type EMS approximate estimate on a basis of unit prices of components in the plurality of records in a session indicating a given period of time to yield a first determination result;
upon detecting that the first determination result is a first positive result, setting a determination result for the session to a value indicating the estimate type as the proposal type EMS approximate estimate;
upon detecting that the first determination result is a first negative result, a second determination for determining whether the estimate type is any one of the proposal type EMS detailed estimate and the ODM detailed estimate on a basis of series of components in the plurality of records in the session to yield a second determination result;
upon detecting that the second determination result is a second positive result, a third determination for determining whether the estimate type is the proposal type EMS detailed estimate or the ODM detailed estimate on a basis of specifications of components in the plurality of records in the session to yield a third determination result; and
upon detecting that the third determination result is a third positive result, setting the determination result for the session to a value indicating the estimate type as the proposal type EMS detailed estimate.

6. The information processing apparatus according to claim 5, wherein the first determination processing further includes counting, in the session, a number of records of the log information about components of which unit prices are equal to or more than a unit price of the original component, and
upon detecting that a first ratio of the counted number of records in the log information with respect to a total number of records in the log information in the session is equal to or more than a first determination threshold value for determining that the estimate type is the proposal type EMS approximate estimate, outputting the first positive result.

7. The information processing apparatus according to claim 5, wherein the second determination processing further includes counting, in the session, a number of records in the log information of which series match series of the original component, and
upon detecting that a second ratio of the counted number of records in the log information with respect to a total number of records in the log information in the session is equal to or more than a second determination threshold value for determining that the estimate type is either the proposal type EMS detailed estimate or the ODM detailed estimate, outputting the second positive result.

8. The information processing apparatus according to claim 5, wherein the third determination processing further includes counting, in the session, a number of items in the log information of which specifications match specification of the original component, and
upon detecting that a third ratio of the counted number of items in the log information with respect to a total number of items in the log information in the session is equal to or more than a third determination threshold value for determining that the estimate type is the proposal type EMS detailed estimate, outputting the third positive result indicating that the estimate type is the proposal type EMS detailed estimate, and upon detecting that the third ratio is less than the third determination threshold value, outputting a third negative result indicating that the estimate type is the ODM detailed estimate.

9. The information processing apparatus according to claim 8, wherein the processor is further configured to perform:
in an analysis period longer than the session, counting a number of records according to the estimate type by referring to the first to third determination results determined for the session, and determining that the estimate type that appears in a largest number of records is the attribute of the first or second operator.

10. A component selection method comprising:
extracting, on a basis of a first component selection criteria for a first component search performed by a first operator, a second operator who performs a second component search with a second component selection criteria which is same as the first component selection criteria; and
generating alternative proposal information by referring to log information about the second component search performed by the second operator.

11. A non-transitory computer-readable medium recorded with a component selection program for causing a computer to perform operations comprising:
extracting, on a basis of a first component selection criteria for a first component search performed by a first operator, a second operator who performs a second component search with a second component selection criteria which is same as the first component selection criteria; and
generating alternative proposal information by referring to log information about the second component search performed by the second operator.
